(19) United States
(12) Patent Application Publication
(10) Pub. No.: US 2025/0289180 A1
(43) Pub. Date: Sep. 18, 2025

(54) Rotary 3D Printer for Rotating DLP System and Method of Operating the Same

(71) Applicant: Drexel University, Philadelphia, PA (US)

(72) Inventors: Nicolas J. Alvarez, Drexel Hill, PA (US); Giuseppe R. Palmese, Hainesport, NJ (US); Jada M. Jackman, Philadelphia, PA (US); Jonathan Wacker, Mechanicsburg, PA (US); Matthew Cordia, St. Louis, MO (US)

(21) Appl. No.: 19/079,949

(22) Filed: Mar. 14, 2025

Related U.S. Application Data
(60) Provisional application No. 63/565,205, filed on Mar. 14, 2024.
(60) Provisional application No. 63/642,317, filed on May 3, 2024.

(51) Int. Cl. B29C 64/241; B29C 64/245; B29C 64/264; B29C 64/393; B33Y 30/00; B33Y 50/02

(52) U.S. Cl. CPC B29C 64/241; B29C 64/245; B29C 64/264; B29C 64/393; B33Y 30/00; B33Y 50/02

(57) ABSTRACT

A 3D printer system combines the techniques of DLP (Digital Light Printing) vat polymerization with a rotating build plate and a resin coating system. The printer operates by pumping resin onto the disk shaped build plate as the plate rotates on the Z axis, coating the plate with a first layer. A UV projection then projects the desired object with the rotation of the printer, and cures the resin via photopolymerization. Software has been developed to map the desired layers of the object onto the rotating plate. The software takes an STL or ACSII file and generates a full printing video. Additional software controls the printing system, and starting with user inputted variables of printer speed, direction, and layer height, controls the printer system for all printing steps.

### CROSS-REFERENCE TO RELATED APPLICATIONS

The present application claims the benefit of U.S. Provisional Patent Application Ser. No. 63/565,205, filed on Mar. 14, 2024 and U.S. Provisional patent Application Ser. No. 63/642,316, filed on May 3, 2024, both of which are incorporated herein as if fully set forth.

### STATEMENT OF GOVERNMENT INTEREST

This invention was made with government support under Contract Nos. W911NF-14-2-0217 and W911NF-24--2-0134 awarded by Army Research Laboratory and Contract No. CBET-1847140 awarded by the National Science Foundation. The government has certain rights in the invention.

### BACKGROUND OF THE INVENTION

### Field of the Invention

The invention relates to a rotary three dimensional printer and the use of reinforced high performance thermoset polymers using the printer.

### Description of the Related Art

Fiber reinforced polymers have applications in aerospace, military, and transportation industries because of their high modulus to weight ratios. These lightweight materials are necessary to increase fuel efficiency and decrease overall weight. Modern commercial planes are typically made up of more than 50% composite materials by mass. Fiberglass and carbon fiber reinforced polymers are the most common composites found in the aeronautical industry. Composites are also utilized in the space industry for the additional benefit of high thermal resistance. When resin is heavily reinforced with chopped fibers, the resulting composite becomes too viscous to be used in conventional resin 3D printers.

It would be beneficial to provide a 3D printer and UV curing system that is capable of printing high viscosity potentiated thermoset polymers. And that can selectively reinforced a printed object with highly aligned fiber clusters.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention is a three-dimensional rotary printer assembly comprising a chassis, a platform rotatingly mounted on the chassis, and an ultraviolet (UV) projector fixed to the chassis and projected onto the rotating platform.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a printer system constructed according to an exemplary embodiment of the present invention;

FIG. 2 is a schematic drawing of the printer of FIG. 1;

FIG. 3 is a top plan view of a rotating platform used with the printer of FIG. 1;

FIG. 4 is a projector and mirror used with the printer of FIG.

FIG. 5 is an exemplary flowchart showing information flow for the printer of FIG. 1;

FIG. 6 is a side elevational view of the printer of FIG. 1;

FIG. 7 is an exemplary Graphical User Interface (GUI) used with the printer of FIG. 1;

FIG. 8 is a schematic view of a slot die extruder for use with the printer of FIG. 1;

FIG. 9 is a schematic view of a constant shear manifold for use with the printer of FIG. 1, with extrusions along a timeframe;

FIG. 10 is a schematic view of a coat hanger manifold for use with the printer of FIG. 1, with extrusions along a timeframe;

FIG. 11 shows fibers aligned in a left-to-right direction according to the present invention;

FIG. 12 is a series of micrographs showing the sequential layering of fibers on a platform;

FIG. 13 is a perspective view of a 3D printed product using the printer of FIG. 1 based on the sequential layering shown in FIG. 12;

FIG. 14 is a graph showing center-to-center distances of first and second layers of printing before and after correction;

FIG. 14A is a micrograph showing fiber layering before center-to-peak (C-t-P) Correction;

FIG. 14B is a micrograph showing fiber layering after C-t-P Correction;

FIG. 15 is a schematic view of deposited filaments and model parameters according to an exemplary embodiment of the invention;

FIG. 16A is a graph showing thixotropic recovery timescales for both cases of in-situ cured and uncured DA2+5% silica;

FIG. 16B is a graph showing increase in basal radius during spreading for both cases of in-situ cured and uncured DA2+5% silica;

FIG. 17 is a graph showing basal radius of DA2+5% silica particle filaments at different relative distances;

FIG. 17A shows the cross-section sizes of two deposited filaments at different λ_{c} values in an uncured condition;

FIG. 17B shows the cross-section sizes of two deposited filaments at different λ_{c} values in an in-situ cured condition at 2.2 mW/cm²;

FIG. 17C shows a comparison of te cured and uncured conditions at an optimal λ_{c};

FIG. 18 shows normalized height of two filaments at varying λ_{c} for uncured and in-situ cured conditions at different UV-light intensities;

FIG. 19 shows a step-by-step optimization strategy for deposition of filaments using a Newtonian fluid;

FIG. 20A shows normalized height of multiple filaments at varying λ_{c} for an in-situ cured condition at UV-light intensity of 2.1 mW/cm²;

FIG. 20B shows normalized height of multiple filaments at varying λc for an uncured condition;

FIG. 21 shows the cross-section of five deposited filaments printed with in-situ UV-curing (light intensity of 2.1 mw/cm2) for different λ_{c} values;

FIG. 22A displays the cross-section of two deposited layers, each consisting of five filaments arranged in rows under in-situ cure condition;

FIG. 22B shows a 3-D profilometer image of the first printed layer of FIG. 22A; and

FIG. 22C shows a 3-D profilometer image of the second printed layer of FIG. 22A.

### DETAILED DESCRIPTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The word “about” is used herein to include a value of +/−10 percent of the numerical value modified by the word “about” and the word “generally” is used herein to mean “without regard to particulars or exceptions.”

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Thermoset polymers are widely used in vat polymerization techniques, such as stereolithography (SLA) and digital light processing (DLP), where the polymer is cured with a laser or UV light respectively. Vat polymerization allows for much higher resolution and accuracy since the process is only limited by the UV light resolution, from 50 to 10 μm. DLP has the added benefit of full layer polymerization, a single layer is cured simultaneously and completely.

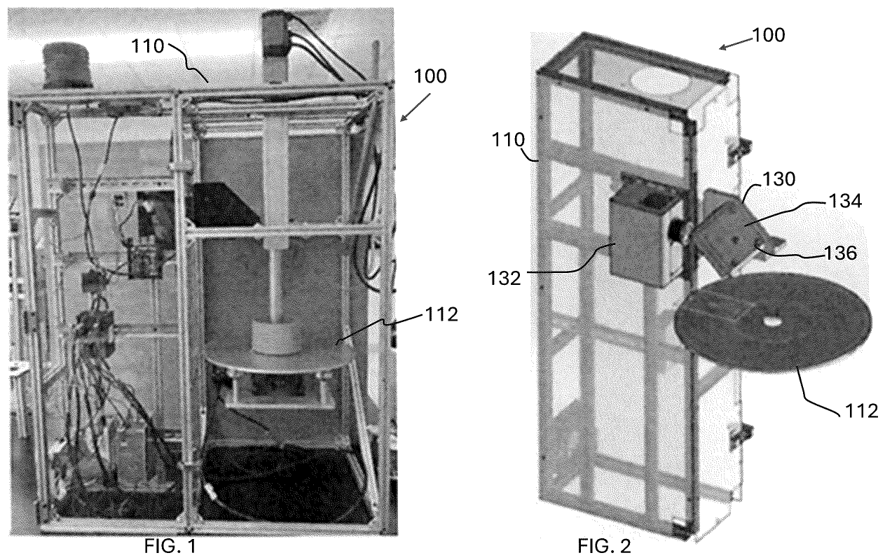

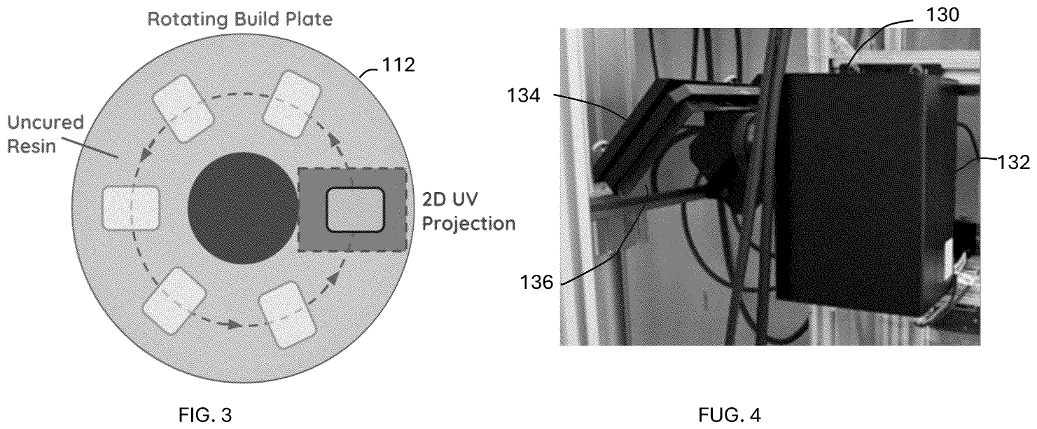

The present invention provides a resin based 3D printer system that can have multiple parts on a rotating bed with reinforcement capabilities. Referring to FIGS. 1-4, a printer system 100 (printer 100) includes a chassis 110 that is the main structural component printer 100, with rotating platform 112.

A curing system 130 is also provided. Curing system 130 includes an electronics enclosure 132. A 3 watt DLP ultraviolet (UV) projector 134 is fixed to the chassis 110 and is projected onto the rotating platform 112 via a mirror 136.

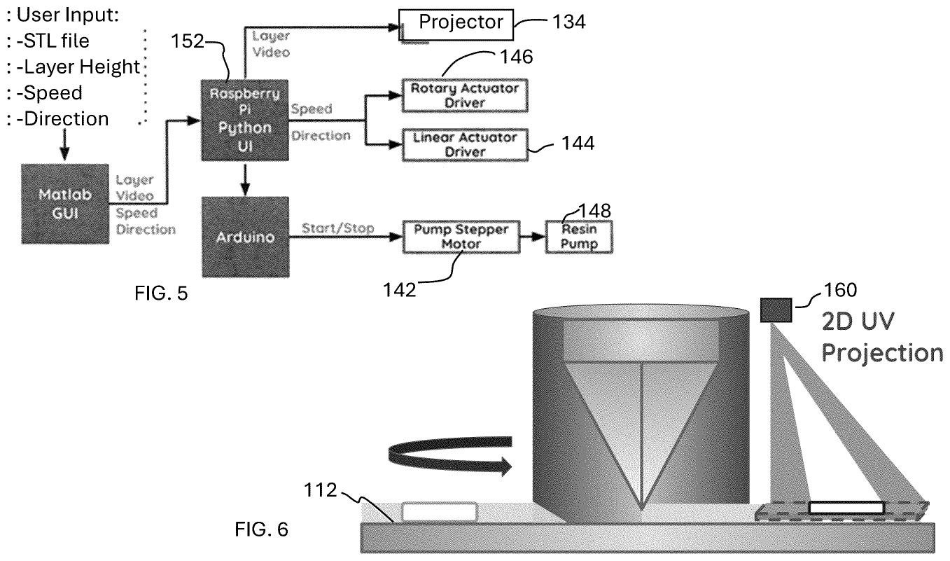

Referring to FIG. 5, exemplary electronics used to operate the printer 100 include a stepper motor 142 for operating a resin pump 148, a linear actuator 144 for moving a print head, a rotary actuator 146 for rotating platform 112, a UV printer with pump 148, an Arduino Uno 150, and a Raspberry Pi 4 152. While stepper motor 142 is presently used, those skilled in the art will recognize that a continuous meter mixing pump (2-part pump) system can be used.

A Raspberry Pi 4B is used as a hub to communicate with the user interface (UI) and control the electronics. A 2-Channel Isolated RS485 Expansion HAT is attached to the Raspberry Pi 152 to allow RS-485 communication with the motor drivers 144, 146. An Arduino UNO Rev 3 150 is connected via USB and serial communication to the Raspberry PI152 and is used for controlling the stepper motor 142 for resin deposition.

An Arduino Motor Shield Rev 3 is attached to the Arduino 150 to allow for easier motor control and communication. Oriental Motor AZD-KX Closed Loop Drivers are connected to the linear and rotary actuators 144, 146 to allow for easier motor control and communication.

During operation of printer 100, in an exemplary embodiment, a single rotation of platform 112 will take up to 60 seconds, so the curing system cures a single layer within that time. Thos skilled in the art, however, will recognize that the speed could change based on the type of resin being used as the print medium, the pump speed, the size of the platform 112, and desired layer thickness. The velocity of the platform 112 is equal to the pump flowrate over the coating thickness times the width of the slot die and is limited by the cure depth at a given power density out of the UV projector 160.

A UV DLP projector 160, shown schematically in FIG. 6, is provided as the energy source for photopolymerization, which has a high resolution and a large power density to cure the resin in about 1.62 seconds. As a safety feature, it is desired that printer 100 be used with UV protective goggles and gloves but can be built out with an enclosure to block the harmful wavelength. An exemplary projector 160 used for printer 100 is a PDC05-70 from Xiamen Zhisen Electromechanical Equipment. Projector is a 405 nm projector that generates a 3-watt output. Projector 160 is mounted directly to the chassis 110 and projects directly at a First Surface Mirror 136 from Edmund Optics. The coating and design of the mirror 136 allow for greater than 95 percent reflectivity of UV light. Mirror 136 is directly above the print platform 112.

An exemplary resin with printer 100 DA-2 with an anti-caking agent, such as 5% Cabosil, and poly (p-phenylene oxide) (PPO) is used to initiate the UV reaction. A desired minimum viscosity of the printed resin is 150,000 cps to have a system capable of printing reinforced parts. The required energy output of the projector to cure 1 mm of resin requires need 38 mJ/cm².

It was determined that for a 3 W energy output, which is the maximum output of the projector, at 1 mm layer height, the resin will cure after about 1.5 seconds. The power density is about 13 mW/cm². This means that a cure time of at least 3 seconds is required.

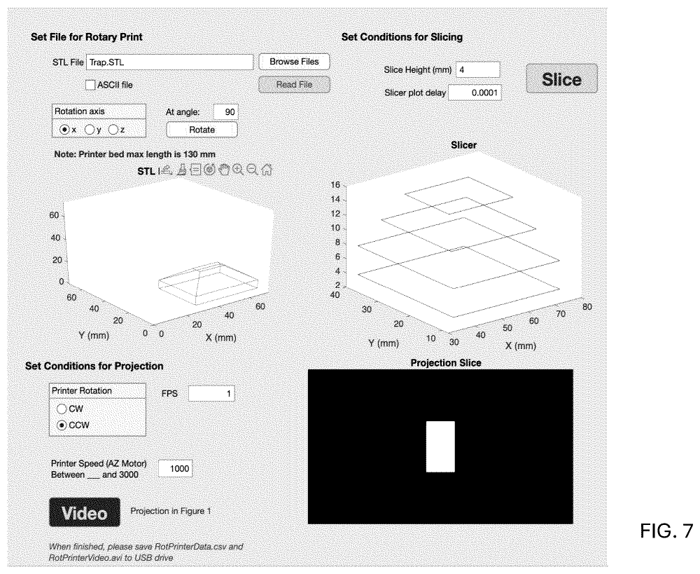

Printer 100 is a new design type and requires a solution for its unique requirements of STL file slicing and projection. Due to the rotation of the printer platform 112, the projected layer image must also project at the same rotation rate as the printer platform 112. This necessitated the development of a slicing program unit for the printer 100. This software was developed through Matlab, with a UI in the Matlab app system to walk the user through variable inputs and display the steps of the slicing process. A still image of a GUI used with this system is shown in FIG. 7.

The app can slice an STL or ASCII file built through a desired CAD program. From the sliced file of a user-inputted layer height, the program generates a video file of the rotating object on the print platform 112 at the user-inputted speed and rotation direction. This slice is rotated by multiplying the original object by a rotation matrix and inserting the frames of the object at the projector location of the circle. The program has been optimized for speed of run time so the video can be produced and saved within a reasonable time. Variables such as layer height, rotation direction, and rotation speed have been programmed to aid in testing the printer with different conditions. All variable inputs within the slicing program correspond to changes in the printer movements. For example, a change in layer height changes both the height of the slice in Matlab and the height of the printer movement in the Z axis.

Once the video files have been produced for the 3D object, the files are moved to the 3D printer setup via USB. This is similar to the process of how other commercial 3D printers work, such as the Ender 3 pro which works by uploading sliced files via USB or micro USB. The user needs to import both a video file and a text file to the designated folder on the Raspberry Pi device 152, and then use a Python UI to run the printer. While hardwire is presently used, those skilled in the art will recognize that wireless communication, such as Bluetooth communication, can be used.

The Python UI program locates the text file on the USB and ensures the printer runs to those specifications, with the user-chosen variables, printer speed, printer direction, and layer height/number. The video file is also located and is moved to the projector 160 to be projected for every slice on every rotation. The user is asked to clear the platform 112 before starting, then the printer moves to its set starting position. This is achieved by sending commands to the AZ series motor drives, connected to the rotation motor and the Z-axis motor. The printer then starts rotation of the platform 112 in the user-selected direction, counterclockwise or clockwise, and starts to dispense out resin.

The resin pump 148 is controlled by Arduino 150 with a motor shield board and stepper motor 142. The system runs by serial communication between the Arduino Uno 150 and the Raspberry Pi 152. The Pi in Python sends a command to the step motor for each action it needs to take corresponding to the printing process. The software commands the motor to turn on and push the resin out of the pump 148 when the platform 112 rotates. The software then sends a stop command when the end of the rotation is reached, and sends a reverse command when it is time to refill the resin pump 148 and draw in. The user does not interface with any of these commands.

The video is projected in time with the rotation of the printer platform 112, and the first layer can be cured with UV projection. After a full rotation, the printer platform 112 steps down the amount of the layer height and steps up before coming in contact with the previous layer, which is now higher than the platform 112. Then the printer 100 continues until all layers have been printed, after which the platform 112 can be lowered, and the printed object can be removed.

Glass fiber reinforcements 170 were tested and glass fiber was able to be cured, likely due to the fact the glass fiber allows for the UV light to pass through to the whole layer. The glass fiber reinforced resin cured at a depth of 1 millimeter.

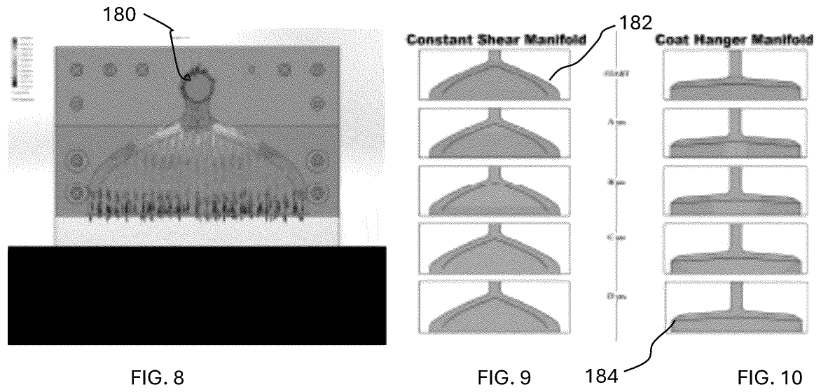

Instead of point printing, printer 100 can be affixed with a slotted die head 180, shown schematically in FIG. 8, to deposit resin over a broader surface. Different die heads 180 can be used, such as a constant shear manifold 182, with its deposition effects shown in FIG. 9, a coat hanger manifold 184, with its deposition effects shown in FIG. 10, or other type of manifold.

Typically, glass fiber reinforcement is applied with the fibers extending in various random directions. It has been found, however, that by aligning the fibers in a single direction, printed material can be selectively strengthened. Similar to rebar in concrete, aligned glass fibers in polymer can selectively strengthen the polymer along a desired direction, resulting in highly aligned fiber clusters. In an exemplary embodiment, the fibers can be between about 6 mm and about 7 mm in length, although those skilled in the art will recognize that the fibers can have different lengths.

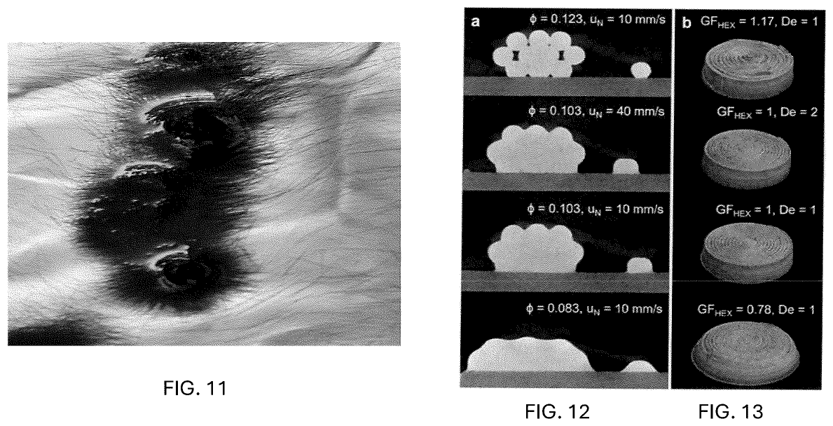

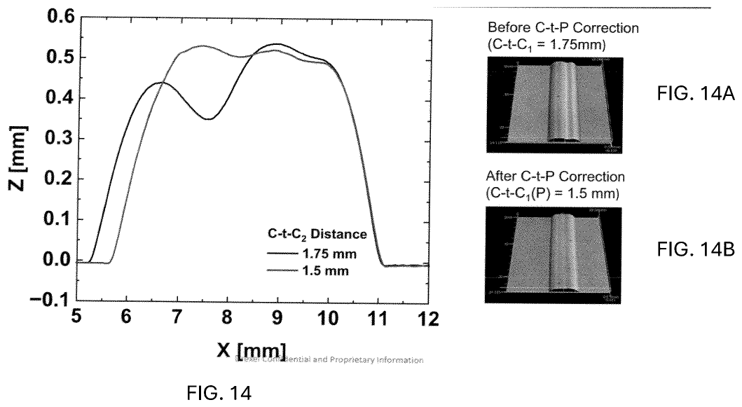

An exemplary device used to distribute fibers is disclosed in U.S. patent application Ser. No. 17/631,556, owned by the Applicant, which is fully incorporated herein as if fully set forth. FIG. 11 shows fibers generally aligned in a left-to-right direction using the device of the '556 application.

An exemplary device used to print using the fibers is disclosed in U.S. patent application Ser. No. 18/679,014, owned by the Applicant, which is fully incorporated herein as if fully set forth.

The highly aligned fibers discussed above can also be used in Direct Ink Writing (DIW). DIW is a state-of-art 3D material extrusion printing technique with several key advantages, including the ability to process a wide range of fluids, print on non-planar substrates, ability to print different materials simultaneously and incorporate reinforcement fillers directly during the printing process. For example, DIW has been utilized to fabricate 3D structures from diverse materials, including thermosets, functional polymers, polymer nanocomposites, and colloidal suspensions. Furthermore, DIW enables the fabrication of large-format components, making it a versatile and powerful tool for advanced manufacturing. In this process functional inks, typically non-Newtonian fluids or viscoelastic materials, are extruded through a nozzle and deposited in the form of individual filaments on the printing bed in a line-by-line, layer-by-layer fashion to create a complex three-dimensional part. The overall structure and mechanical properties of DIW-printed components are strongly influenced by the rheological properties of the ink as well as the shape and degree of overlap between adjacent filaments.

A significant challenge in DIW lies in the uncontrolled spreading of deposited filaments right after deposition, which complicates the precise translation of 3D models into printed structures. This often results in deviations from intended dimensions. Such limitations in process control can lead to poor geometric fidelity, dimensional inaccuracies, and substantial inter-structural voids, all of which compromise the mechanical integrity of the final printed part. Addressing these issues typically requires significant effort, involving extensive trial-and-error parameter optimization for each combination of ink and printer. The present invention optimizes the spatial arrangement of deposited filaments by leveraging the rheological characteristics and spontaneous spreading behavior of inks, wherein the placement of a second filament depends on the spread of the first filament. This approach aims to achieve void-free printed structures while preserving dimensional accuracy, providing a framework for efficient parameterization of DIW printers.

Ink design is a critical factor in achieving successful DIW parts and has been extensively studied. More specifically, current wisdom suggests that inks must exhibit shear-thinning behavior to enable smooth extrusion and rapid viscoelastic recovery to preserve the shape of deposited filaments. Highly loaded inks are often employed to produce cylindrical filaments resembling those in fused deposition modeling (FDM) processes. However, such inks frequently result in voids between filaments, a.k.a rhombic voids, which acts as stress concentrators and lead to premature crack initiation that compromises mechanical integrity. Furthermore, even highly filled inks undergo deformation and spreading due to the thixotropic behavior of the suspensions, i.e. the shear within the nozzle causes disruption of the colloidal network, which requires time to recover, and leads to unexpected spreading post-deposition.

Some amount of spreading is desirable in order to eliminate the rhombic voids typical in extrusion additive manufacturing. For example, in the printing of thermoplastics, the viscosity of the deposited filaments is so high that very little spreading and coalescence occurs between filaments, which leads to large voids per layer and poor cohesion between subsequent filaments.

However for low viscosity thermosets, controlling the spreading is difficult, and it is not obvious which final deposited shape is most favorable for eliminating voids. In-situ photo-curing is a common technique employed to partially or fully cure material during printing and control the post-deposition spreading. However, the shape as a function of curing is a complex relationship between inertial driven spreading and monomer conversion, especially when oxygen inhibition delays the polymerization reaction. Nonetheless, rapidly increasing the modulus through photo-curing broadens the range of printable materials, including low-viscosity inks, and reduces the need for rheological modifiers. Managing bead spreading during deposition has been shown to effectively reduce the size and number of inter-structural voids, thereby improving the overall quality of printed structures. However, trial and error approaches have not yet achieved parts where the voids and defects are completely eliminated.

Given that some degree of spreading is unavoidable regardless of ink formulation, curing rate, or DIW printing technique, a systematic study of bead spreading, coalescence, and overlap is needed to predict final part fidelity. Similar approaches have been taken using FDM printing to minimize the voids between filaments by either controlling printing parameters or adjusting spacing, i.e. the center-to-center distance between deposited filaments. For example, the mechanical strength of FDM printed parts can be increased by 10-50% by reducing voids in interfacial regime. Rodriguez et al. have reported that the mechanical strength of printed parts highly depends on the shape of the voids, with different strengths observed from the aligned and skewed shape of the voids. Voids can be reduced by increasing extrusion temperature increase the mechanical properties (i.e., strength and modulus) up to 11%.

The present invention establishes a correlation between the spontaneous spreading behavior of photo-polymerizable inks, the spacing between deposited filaments, and the size and shape of voids between filaments. More specifically, we show that there exists an optimum center-to-center distance between subsequent filaments that minimizes voids and defects, which is a function of the steady-state spreading radius of the previously deposited filament. Furthermore, the optimum center-to-center distance is a function of the number of filaments printed. This strategy seems to be general and can be applied to filaments with and without in-situ photo-curing. The novelty of this work is to take advantage of the spontaneous spreading to achieve maximum overlap and uniformity between subsequently deposited filaments. The approach is structured as follows: For two common DIW scenarios-uncured filaments and in-situ cured filaments during printing, first, we characterize the rheological properties of the inks and their spontaneous spreading behavior. Next, we optimize the positioning of two adjacent filaments to minimize the voids in-between. Finally, we extend our analysis to multiple adjacent filaments and multilayered structures, providing insights into the scalability of the proposed approach.

The DIW ink is composed of three monomers: Bisphenol A glycerolate dimethacrylate (Bis-GMA, Mw 512 g/mol), ethoxylated bisphenol A dimethacrylate (Bis-EMA, Mw 540 g/mol), and 1,6-hexanediol dimethacrylate (HDDMA, Mw=254 g/mol). The ink formulation is known as DA2 and its physical properties are known. 2 g of fumed silica particles with 0.27 g of photo initiator (phenylbis (2,4,6-trimethylbenzoyl) phosphine oxide) were mixed with 38 g of DA2 resin to produce 5 wt. % of gel state of silica particle mixture. The mixing was performed for 20 minutes at 1800 rpm using a Thinky mixer, followed by 5 minutes of defoaming step at 500 rpm. The mixing step was repeated at least twice to obtain the uniform dispersion of the particles.

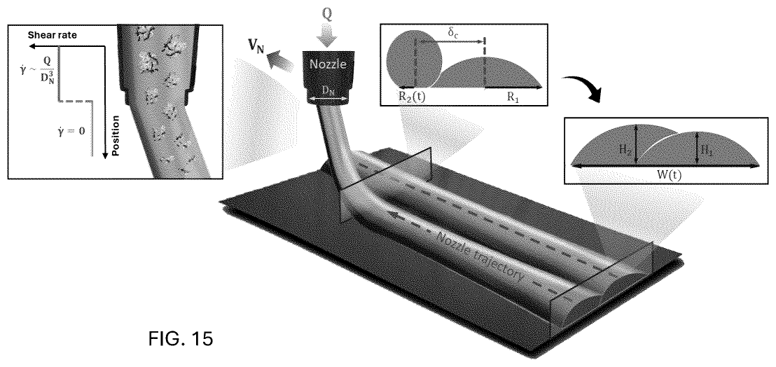

Overlapping experiments were performed with a Direct Ink Writing (Delta WASP, 2040 CLAY) printer with a novel 45° mirror stage to monitor filament spreading from underneath the glass substrate via a microscope camera. The detailed experimental procedures are described previously. FIG. 15 schematically shows the process parameters and important parameters characterizing the deposition and shape of subsequent filaments. The shape, heights and widths, of subsequent filaments were studied as a function of the center-to-center nozzle distance, δ_{c}.

Two printing conditions were studied: with and without photo-curing during spreading. First, we investigated the overlapping behavior without curing. After depositing the first filament, 150 seconds of waiting time was applied before printing the next filament to ensure the first filament had reached a steady state shape. Second, the printing was performed under UV light, with wave-length range between 275-450 nm. This study was performed continuously such that the second filament was deposited within 1-3 seconds of the first. In all cases, the operating parameters were kept constant, i.e., the nozzle velocity, V_{N}=69 mm/s, the infill flow-rate Q=4.0 ml/min, the inner diameter, D_{N}=0.63 mm. Note that this operating conditions correspond to an initial filament size of R₀=0.55 mm, calculated using R₀=(Q/ΠV_{N})^{0.5}, as previously shown.

The center-to-center distance (δ_{c}) was varied from 1.0 mm to 3.04 mm. The basal radius of the second filament, R₂(t), was estimated from both microscope imaging and 3D profilometer using

$${R}_{2} ( t ) = W ( t ) - {R}_{1} - {δ}_{c} , \qquad ( Eq . 1 )$$

where W(t) is the total width of filaments, R₁ is the final width of filament I, and δ_{c} is the center-to-center distance between the nozzle while printing first and second filaments. In the case of uncured deposited filaments, the filaments were post cured after reaching steady state for imaging purposes using the above mentioned UV lamp. The final height of filament 1, H₁, and filament n, Hₙ were measured using a 3D profilometer (Keyence, VR 6000). The images were taken in the area of 24×18 mm with 25× magnification. Note that in the case of uncured filaments there was an 8% volume shrinkage during post curing, which causes an 8% decrease in height and basal radius after curing.

To further analyze the behavior of deposited filaments, we employed numerical modeling to simulate the overlapping of deposited filaments, focusing on a simplified case involving Newtonian fluids. The governing equations are consistent with those detailed in our previous study on the spreading dynamics of individual Newtonian filaments. The shape of previously deposited filaments was used as a boundary condition. Specifically, on one edge, the filament spreads freely over a flat wall, while on the other edge, it spreads over a curved surface resembling the final configuration of the preceding filament. To ensure the independence of the results from a mesh grid spacing, we adopted a minimum mesh size criterion of R₀/30 following established practice. To maintain a mesh quality above 0.1, a dynamic remeshing strategy was implemented, enabling the dynamic reconstruction of the entire mesh domain during the simulation. The Finite Element Method (FEM) model parameters were retained from our prior work, and the governing equations were solved using COM-SOL Multiphysics v.5.6 within a 2D framework to capture the dynamics of multiple filament spreading.

Spontaneous spreading of individual filaments is driven by the interplay of gravitational and capillary forces resisted by inertia and viscous dissipation. Key factors influencing spreading include the fluid rheology (viscosity), Bond number (Bo=ΔρgR₀²/σ), and the static advancing contact angle (Bs). In terms of fluid rheology, viscosity serves as the primary dissipative force, governing the spreading rate and timescale. For complex fluids, such as non-Newtonian inks with thixotropic behavior, the process becomes more intricate, as viscosity is influenced by both shear rate dependence and the fluid's shear history.

Furthermore, in cases where there is an in-situ polymerization while spreading, it is even more challenging since the viscosity is a function of conversion.

Most DIW inks are colloidal suspensions, where dispersed particles modify rheology and enhance mechanical properties. These suspensions often exhibit thixotropic behavior, with viscosity recovery dependent on resin type, additive composition, and concentration. Predicting the spreading of colloidal inks is not trivial due to the processing history and the complex time-dependent material parameters. During the D1W process, ink is extruded through a nozzle and deposited onto the printing bed. Before deposition, the ink experiences high shear rates in the tubing and nozzle, which disrupts the colloidal network and reduces the ink viscosity, facilitating extrusion. The shear rate within the tubing and nozzle is proportional to the extrusion flow rate and inversely proportional to diameter. The average shear rate under operating conditions (Q=4 ml/min and nozzle D_{N}=0.6 mm) was estimated to be 1566 s⁻¹ using a Carreau-Yasuda model. Upon exiting the nozzle, the shear rate abruptly drops, causing the ink viscosity to recover via reformation of colloidal aggregates, which increases the elastic modulus. The elastic modulus is argued to be important in maintaining the printed structure during additional deposition. However, the thixotropic behavior of colloidal inks introduces a time-dependent recovery of viscosity after extrusion, which determines the amount of spreading after deposition. Moreover, for DIW printing with in-situ photo-curing, the amount of spreading is also affected by simultaneous polymerization, since both the viscosity recovery and the cross-linking kinetics play role in the final filament shape.

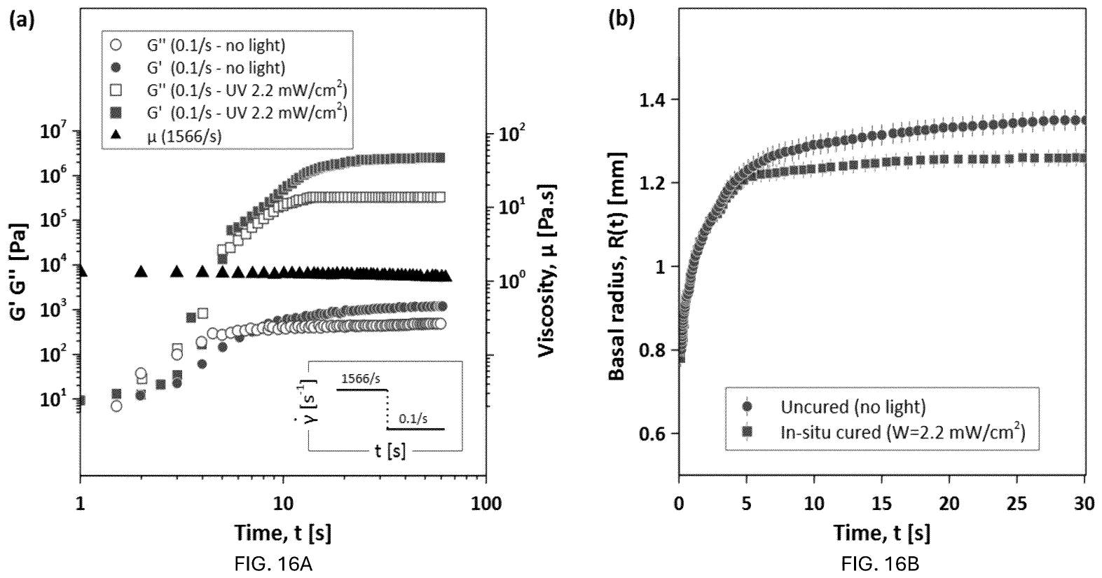

The effect of thixotropy on the recovery of viscosity and modulus was determined via step-change in applied rate. First the pre-sheared sample was subjected to a high shear rate of 1566⁻¹, followed by an small amplitude oscillatory measure of moduli (G′ and G″) as a function of time for two cases; i. uncured resin, and ii. simultaneous photo-curing. The sample was pre-sheared at a rate of 0.1 s-I for 60 seconds, The rate of 1566 s⁻was chosen to mimic the average shear-rate in the nozzle prior to deposition. A step-down shear rate of 0.1 S-I was applied, and the evolution of G′ and G″ was monitored. One measure of the thixotropic recovery timescale of a colloidal suspension is the crossover time of G′ and G″, indicating that the elastic modulus is on the same order of magnitude as viscous modulus. Note that this definition also corresponds to the maximum in tan δ. As shown in FIG. 16A, the thixotropic recovery timescales for both cases of in-situ cured and uncured are approximately 5 and 10 seconds, respectively. The faster thixotropic recovery timescale for the in-situ curing experiments demonstrate that the cure kinetics should influence the spreading behavior.

Spreading has two important timescales: an inertial-driven timescale, typically on the order 1O⁻³s, and a viscous-driven timescale, typically on the order of 1O⁻²s considering the solvent viscosity only. For both cases, the thixotropic recovery timescale exceeds both spreading timescales, and thus significant spreading is expected. We measured the basal radius of individual filaments on glass slides under two conditions: without curing and with in-situ curing (UV intensity 2.2 mW/cm²). As shown in FIG. 16B, both cases exhibited a 50-75% increase in basal radius during spreading, confirming significant spreading and deformation due to delayed viscosity recovery. However, in-situ polymerization and development of crosslinking network freezes the shape of the filament after 5-20 seconds. Note that the ink's yield stress (τ_{y}˜100 Pa) and initial filament radius (R₀=0.55 mm) correspond to a hydrostatic stress (τₕ=2ρgR₀˜12 Pa) that is 10 times smaller than the yield stress. Thus, the fluid would not flow purely due to gravity, yet significant spreading occurs, attributable to thixotropy and delayed moduli recovery. Therefore, while some spreading and deformation are inevitable, in the following we explore leveraging this behavior to improve filling of the voids between filaments in printed parts.

Bo and Θₛ are two other key factors affecting the spreading process. Increasing Bo number or decreasing Θₛ enhances the extent of spreading as gravity dominates and the shape becomes more flat, respectively. For the first layer, Θₛ is determined by the steady state contact angle between resin and substrate. For the subsequent layers, Θₛ is determined by the steady state contact angle between resin and its solidified form. In our case, the substrate was borosilicate glass, which had a measured Θₛ˜19.6° with the studied resinThe Bo is a function of fluid parameters and the initial filament radius, R₀, which depends on the printing parameters. In this study, printing parameters were kept constant, i.e. V_{N}=69 mm/s, and Q=4.0 ml/min, which corresponds to R₀=0.55 mm or Bo=0.1. Therefore, the effect of R₀ on spreading and coalescence is not studied here.

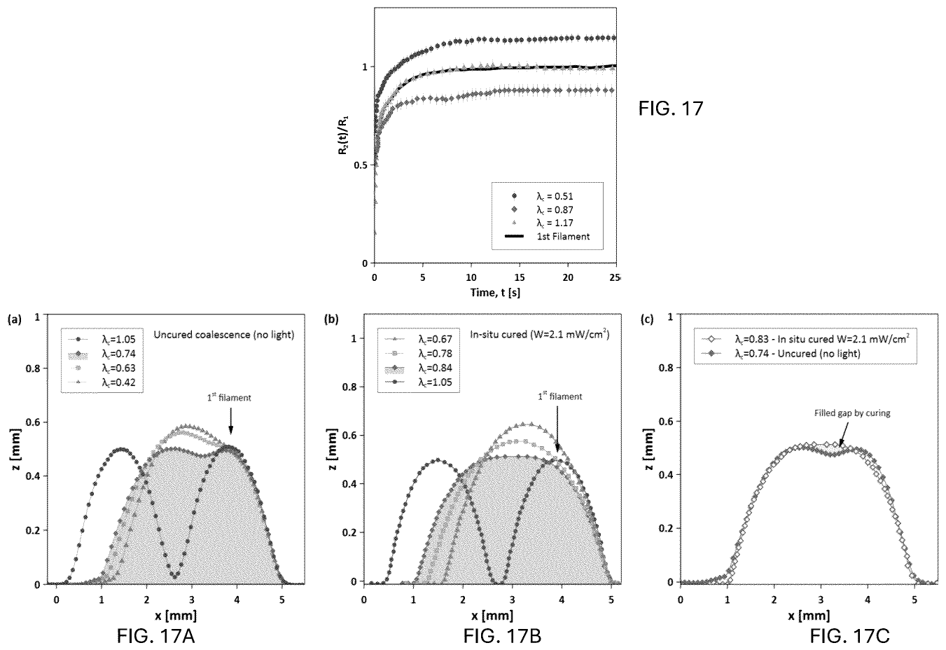

When a filament is deposited next to a previously deposited filament (see FIG. 15), asymmetry arises from differing Θₛ values and curvature at the two edges: one edge in contact with the substrate and the other with a curved solidified resin. This asymmetry alters the spreading extent and filament shape. The spreading dynamics of the second filament's basal radius, R₂(t), is influenced by the height, curvature, and steady-state shape of the first filament, as well as the relative positioning of the second filament. The dimensionless relative position of the second filament to the center position of the first filament is defined as λ_{c}=δ_{c}/2R₁, where δ_{c} is the center-to-center nozzle distance, and RI is the first filament's final basal radius (see FIG. 15). FIG. 17 shows the evolution of R₂(t) at different δ_{c} ranging from 1-2.35 mm. Note that because the centroid of the second filament is moving in time the measure of R₂(t) requires the use of Eq. 1. For large center-to-center distance, i.e. δ_{c}=2.35 mm or λ_{c}>1, R₂(t) follows the spreading of R₁; signifying that the spreading is unaffected by the presence of the nearby filament. As λ_{c} decreases, R₂(t) reaches a much lower steady state value than R₁. At sufficiently small δ_{c}, the spreading of R₂ is enhanced and exceed the spreading of R₁. The results clearly indicate that a minimum in spreading radius occurs at some δ_{c}.

Though the basal radius measurements allow us to determine the spreading rate of two filaments, it does not provide information about the uniformity of the printed filaments. The uniformity of the printed filaments was determined using a 3D profilometer to look at the scanned cross-sectional profile as a function of δ_{c}. FIGS. 17A-17B show the cross-sectional profile of two overlapped filaments with varying λ_{c} between 0.4-1.1 for both uncured and in-situ cured filaments, respectively. When Θλ_{c}>1, there is no overlapping between two filaments and the printed structure is given by two identical separated humps (maximum voids between filaments). When λ_{c}<1, the overlapping increases and the height of the second filament depends strongly on the value of δ_{c}. For values of 0.74<λ_{c}<I, the height of filament 2 is below that of filament I, corresponding to the enhance spreading discussed in FIG. 16. For the uncured filament at λ_{c}=0.74 and the cured filament at λ_{c}=0.84, the heights of the two filaments are almost identical again, and the void between filaments is significantly reduced for the uncured filaments, and almost completely eliminated for the cured filaments. The difference between the uncured and in-situ curing results is better seen in FIG. 17C. For smaller δ_{c}, the void between filaments is eliminated, but the height of the second filament is greater than that of the first. These unexpected result demonstrates that there is an optimum λ_{c} that maximizes layer accuracy and minimizes defect formation. In other words, there exists an optimum line spacing between deposited filaments that depends on the spreading of the previously deposited filament and the curing condition. These results also explain why 3D-printer's slicing parameters are so difficult to optimize, since both the size of the filaments and their optimum line spacing are complicated functions of each other.

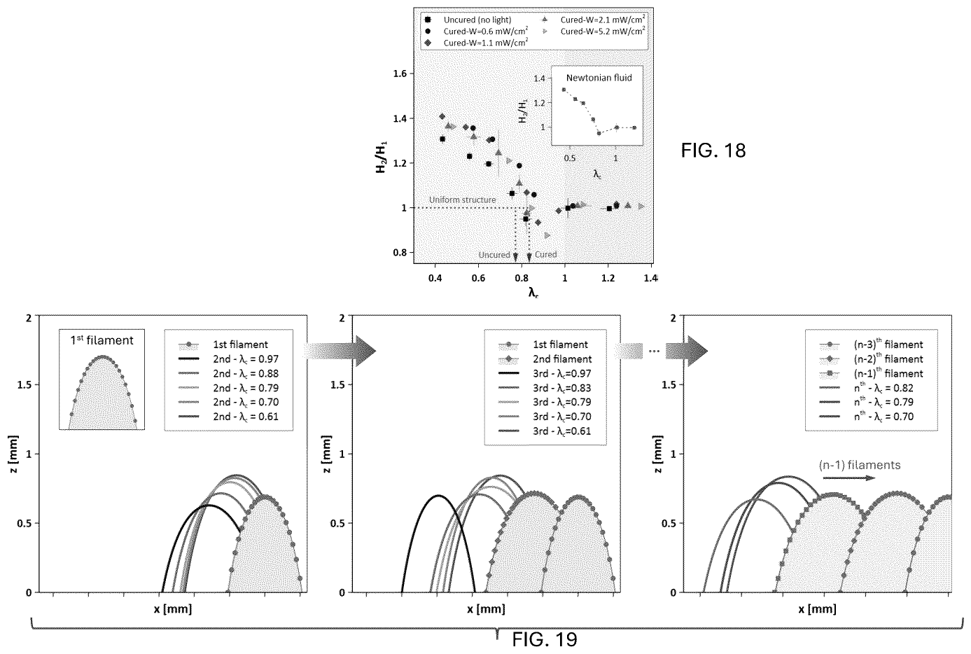

One measure of the layer uniformity is the ratio of H₂/H₁. FIG. 18 shows H₂/H₁ for two filaments at various Ae values for the uncured and in-situ cured cases for varying power density. For all cases, H₂/H₁ initially decreases with increasing δ_{c}, reaches a minimum, and plateaus at δ_{c}≥1. The optimal δ_{c} is restricted to λ_{c}≤1 to ensure filament overlap, and H₂/H₁=1 indicating equal filament heights and layer flatness. As expected from FIGS. 17A-17C, H₂/H₁ occurs at different value of λ_{c} depending on whether the filament is cured in-situ. The optimum spreading for the uncured case occurs at approximately λ_{c}=0.78, and λ_{c}=0.84 for the in-situ curing case. Note that the optimum λ_{c} does not strongly depend on the light intensity for the range tested. Another important point is that the slope of H₂/H₁ near the optimum λ_{c} clearly indicates the importance of accuracy in the center-to-center distance between subsequent filaments. There is almost a one-to-one change in relative height to relative filament spacing in this regime.

The existence of an optimum value of λ_{c} and the minimum value of H₂/H₁ necessitated additional investigation using numerical tools. Using a validated Newtonian spreading model, we mimicked the coalescence process by simulating the spreading of a filament onto a previously deposited filament shape. The simulated H₂/H₁ data are presented in the inset of FIG. 18. Interestingly, we observe the same qualitative trend for Newtonian filaments as the cured and uncured non-Newtonian experiments. Quantitatively, the Newtonian filaments predict an optimum λ_{c}=0.88, which is closer to the result observed for the cured filament case. The Newtonian simulations were performed for different R₁ and Θₛ and result in identical optimum δ_{c}, which suggests that the scaling of δ_{c} with R₁ leads to a general result. Furthermore, the similarities between the Newtonian simulations and the non-Newtonian experiments suggest that the optimal λ_{c} arises from geometrical factors rather than the material rheology.

Recall that the goal is to achieve the most uniform layer of filaments possible, i.e. the layer with the least number of defects to affect the next layer. We conducted optimization of Ae both experimentally and via simulations for Newtonian fluids for several sequential filaments. FIG. 19 illustrates, via numerical simulation, the step-by-step optimization strategy for the n^{th} filament of a Newtonian liquid. The optimization process for multiple filaments was both time-intensive and effort-intensive due to the interdependence of filament positions. For example, the optimal placement of the third filament must first ensure that the second filament was positioned at its optimal center-to-center distance, i.e. δ_{c}. Recall that from the previous section, the optimum experimental determined λ_{c} was λ_{c}=0.78, for the uncured case, and λ_{c}=0.84, for the in-situ cured case. Only after fixing the second filament at its optimum position (within experimental error) did we test different center-to-center distance placements for the third filament, ultimately identifying its optimal position. Note that the optimum position of the third filament, strongly depends on the positioning of the second filament. For the fourth filament, the process grew more complex. We first ensured the optimal placement (within experimental error) of both the second filament and third filament, then determined the height ratio of the fourth filament as a function of δ_{c}. This iterative process extends to the nth filament: all n-1 previous filaments must first be accurately placed at their respective optimal δ_{c,n} values to minimize voids.

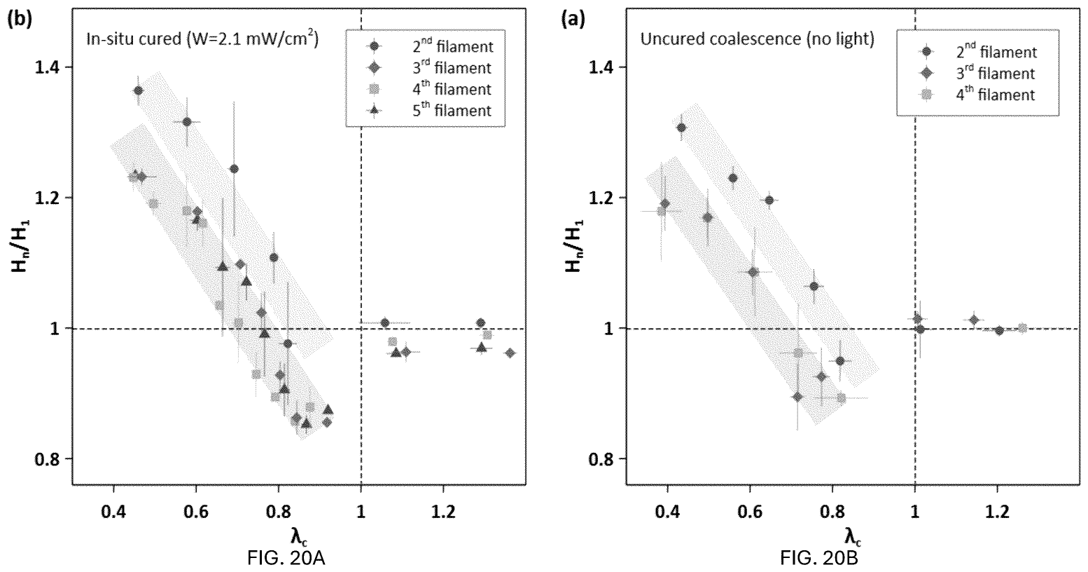

FIG. 20A-FIG. 20B show the experimentally measured Hₙ/H₁ for multiple filaments under both in-situ cured and uncured conditions at a light power density of 2.1 mW/cm². Note that these experimental results are for a silica filled resin and not a Newtonian fluid. Our results showed that the optimal λ_{c} shifted to lower values for the third filament. More specifically, λ_{c} shifts from an optimum value of 0.78-->0.68 and 0.84-->0.74 for the uncured and in-situ cured cases, respectively. Interestingly, the optimal λ_{c} of the fourth filament for the uncured case was very close to that of the third, but not exactly the same. This could be due to experimental error or a slight dependence of the optimum δ_{c}. on the value of n for uncured filaments. However for filaments with in-situ curing, the optimal value of λ_{c} appears unchanged. In other words, for n>2, we observe a significant shift in H₂/H₁ for both the uncured and the cured cases, but the optimum value is a weak function or constant of n for n≥3. Regardless of the number of filaments tested, the in-situ cured filaments have a larger optimum λ_{c} than the uncured filaments. A very similar shift in the optimum λ_{c} is observed for the simulation results of a Newtonian fluid. The shift of the optimum λ_{c} for a Newtonian liquid simulation goes from 0.88→0.83.

Using the numerical simulations, which offer more information than the experimental spreading results, we were able to determine that the shift in the optimal value of λ_{c} for n>2 occurs due to the change in spreading and shape between filament 1 and filament 2. The first filament spreads symmetrically, and its peak position remains stationary and coincides with the nozzle position. In contrast, the second filament undergoes an asymmetric spreading process due to one edge overlapping with the first filament; causing filament 2's peak position to shift toward filament 1. As a result, the nozzle position and the peak position do not align for the second and all subsequent filaments, and the distance between them is non-zero, δₚ not=0. Furthermore, R₂, as discussed in FIG. 17, does not give the same spreading radius as R₁; but has a larger value R₂/R₁ not=1.2 at the optimal λ_{c} value. Both δₚ nt=0 and R₂/R₁ eads to a correction of δ_{c}. If λ_{c} is redefined using the nozzle-to-peak distance, not nozzle-to-nozzle distance, and scaled by the radius of the previously deposited filament, R′ₙ₋₁, which is now measured from subsequent filament's leading edge to its peak position, i.e.

$${λ}_{c}^{*} = ( {δ}_{c +} δ p ) / 2 {R}_{n - 1}^{*} \qquad ( Eq . 2 )$$

the optimum λ_{c}* between filament 2 and filament 3 are identical. Note that the measure of R′ₙ₋₁ is only possible because of the numerical simulations, and as discussed in Equation 1 is not always experimentally possible, since a clear peak for filament 2 is not always experimentally observed. In other words, if one could measure all of these parameters during printing, then only one optimum A; value need be considered. However, it is impractical to measure R′ₙ₋₁ and δₚ during printing because at the optimum λ_{c}* there exists almost no peak, see FIG. 23A-23C. Therefore, the only viable approach is to use λ_{c} in terms of distance between nozzle positions scaled by 2R₁, which requires no in-situ monitoring, but two distinct optimum Ae values: one for the second filament and another for n>2.

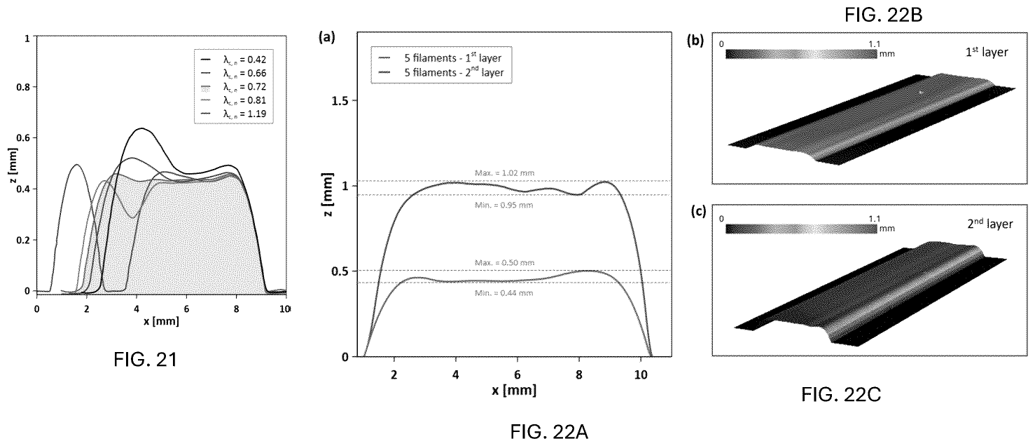

FIG. 21 shows the cross-section of five deposited filaments printed with in-situ UV-curing (light intensity of 2.1 mw/cm²) for different λ_{c} values. In all cases, the second filament was printed with λ_{c}=0.84, while the third and fourth filaments were printed with (λ_{c}=0.74). As shown in the figure, the structure printed with a value very close to the optimal δ_{c}, i.e. λ_{c}=0.74 (blue-shadowed cross-section), exhibits the smallest voids between filaments and a smoother, flat surface compared to the other δ_{c}. These results confirm that the optimal δ_{c}, n=0.74, for 2<n≤5, enables the fabrication of a multi-filament structure with a uniform surface and minimum voids between filaments.

Building on the successful fabrication of a nearly flat first layer, we extended our study to the deposition of a second layer on top of the first. FIG. 22A displays the cross-section of two deposited layers, each consisting of five filaments arranged in rows under in-situ cure condition. The deposition utilized the optimal δ_{c}0.84 for the second filament and δ_{c}, n=0.74 for the remaining filaments. Corresponding 3D profilometer images of the first and second layers are shown in FIGS. 22B and 22C, respectively. The results demonstrate that both layers exhibit nearly flat surfaces with minimal voids between filaments. First and second layers show relative percentage change of 12% and 6.8%, respectively, between the highest peak and the lowest valley. This consistency arises because, once the first layer is printed with a flat surface, the second layer adheres to the same deposition principles as the first layer, with the previous layer serving as the substrate. The primary distinction between printing the first and subsequent layers lies in Os. The fact that the same printing scheme for layer 2 leads to a flat layer supports the simulation results, which show that the optimum λ_{c} does not appreciably depend on the surface energy Θₛ. This important point requires additional discussion.

The spreading of the filament for the first layer involves a surface interaction between resin and printer bed substrate, typically glass or metal, which leads a specific contact angle, Θₛ. In contrast, printing the second and subsequent layers involves resin spreading on solidified resin, which leads to a different Θₛ. However, despite this difference in Θₛ, the second layer seemingly follows the same optimal Θₛ scheme as a function of the n^{th} filament. One explanation is that there is an independence of the optimum λ_{c} on the surface energy, and thus subsequent layers are expected to exhibit fiat surfaces once the flatness of the first layer is achieved.

The results above express the need for a complicated vectorization of CAD models for DIW printing, which results in a line spacing that depends on the number of filaments and the spreading of the first filament on the substrate. The layer vectorization process would proceed as follows:

First, a single filament of the chosen resin must be printed onto the building platform substrate and the final steady state basal radius, R₁, measured.

Second, the center-to-center nozzle position of filament 2 is determined from the optimum λ_{c} for n=2 and R₁ depending on curing conditions.

Lastly, the center-to-center nozzle position of all remaining filaments for a given layer is determined from the optimum δ_{c,n} for n≥3 and R₁ depending on curing conditions.

The optimization strategy above applies for sufficiently straight runs and will lead to minimal voids between filaments, and predictable widths and heights for each layer, which ultimately will lead to increased dimensional accuracy. It is conceivable that step I above could be eliminated with accurate spreading models for individual filaments. Note that there are still unanswered questions, such as: (1) how to treat the issue of acceleration and deceleration around corners and turns, and (2) why there is a difference in λ_{c} for Newtonian and non-Newtonian filaments, but these are outside the scope of this work.

Unlike thermoplastic FDM, thermosets have sufficiently low viscosity to undergo spreading and coalescence between printed lines. While thermoplastic FDM is unable to achieve uniform defect free layers, thermoset resins are capable of producing nearly defect free parts with monolithic integrity. This work introduces a novel extrusion-based printing strategy for thermoset resins, aimed at minimizing voids between filaments and maximizing the dimensional accuracy of printed components. We systematically investigated the interplay between the spontaneous spreading of individual filaments and the coalescence of subsequent filaments, focusing on the impact of line spacing on the overall structure of printed layers. For both uncured and in-situ cured printing scenarios, we identified an optimal line spacing that is only a function of the first filament spreading radius. Furthermore, we demonstrated that the in-situ curing process enhances surface smoothness and further minimizes void formation compared to uncured printed structures. Extending this strategy to multiple filaments and multiple layers, we observed that the optimal line spacing for n>2 filaments differs from that of the second filament, shifting toward smaller values. Thus, current state-of-the-art slicing software that assumes a constant line spacing for a given layer is incapable of defect free printing. Furthermore, the state-of-the-art in ink formulation must take into account the balance between viscosifiers, e.g. colloidal particles, and the spreadability of the ink after deposition: too low of a spreadability would impede coalescence and increase defect sizes. Using the developed optimization criterion, we adjusted filament positioning and successfully applied this approach to the fabrication of multilayer structures with a relatively flat surface and predictable width and height of each layer. Note that the predictability of width and height of a printed layer in extrusion based techniques is a significant achievement in itself.

It will be further understood that various changes in the details, materials, and arrangements of the parts which have been described and illustrated in order to explain the nature of this invention may be made by those skilled in the art without departing from the scope of the invention as expressed in the following claims.

We claim:

1. A three-dimensional rotary printer assembly comprising:
a chassis;
a platform rotatingly mounted on the chassis; and
an ultraviolet (UV) projector fixed to the chassis and projected onto the rotating platform.

2. The three-dimensional rotary printer assembly according to claim 1, wherein the UV projector projects onto the rotating platform via a mirror.

3. The three-dimensional rotary printer assembly according to claim 1, wherein the platform rotates at a speed of up to 1 revolution per minute.

4. The three-dimensional rotary printer assembly according to claim 3, wherein a layer deposited by the printer is cured within one revolution of the platform.

5. The three-dimensional rotary printer assembly according to claim 1, further comprising a rotary actuator driver operatively coupled to the platform to rotate the platform.

6. The three-dimensional rotary printer assembly according to claim 1, further comprising a pump configured to deposit printing material onto the platform.

7. The three-dimensional rotary printer assembly according to claim 1, wherein the pump comprises a stepper motor.

8. The three-dimensional rotary printer assembly according to claim 1, further comprising a slotted die head configured to deposit resin onto the platform.

9. The three-dimensional rotary printer assembly according to claim 8, wherein the die head comprises a constant shear manifold.

10. The three-dimensional rotary printer assembly according to claim 8, wherein the die head comprises a coat hanger manifold.

11. The three-dimensional rotary printer assembly according to claim 1, wherein the printer is configured to project at a same rotation rate as the platform.

12. 1. A three-dimensional rotary printer assembly comprising:
a chassis;
a platform rotatingly mounted on the chassis;
an ultraviolet (UV) projector fixed to the chassis and projected onto the rotating platform;
a pump configured to deposit material onto the platform;
a rotary actuator driver configured to rotate the platform;
a linear actuator driver configured to move the pump; and
a stepper motor configured to operate the pump.

13. The three-dimensional rotary printer assembly according to claim 12, wherein the rotary actuator driver and the linear actuator driver are controlled by a first software program.

14. The three-dimensional rotary printer assembly according to claim 13, wherein first software program further controls the projector.

15. The three-dimensional rotary printer assembly according to claim 13, wherein the stepper motor is controlled by a second software program.

16. The three-dimensional rotary printer assembly according to claim 15, wherein the first software program is configured to transmit data to the second software program.
